(19) United States
(12) Patent Application Publication
(10) Pub. No.: US 2010/0198574 A1
(43) Pub. Date: Aug. 5, 2010

(54) Programmer View Timing Model For Performance Modeling And Virtual Prototyping

(76) Inventor: Yossi Veller, Herzliya (IL)

Correspondence Address: MENTOR GRAPHICS CORP.;PATENT GROUP, 8005 SW BOECKMAN ROAD, WILSONVILLE, OR, 97070-7777, US

(21) Appl. No.: 12/476,935

(22) Filed: Jun. 2, 2009

Related U.S. Application Data
(60) Provisional application No. 61/207,882, filed on Jan. 30, 2009.

(51) Int. Cl. G06F 17/50

(52) U.S. Cl. 703/14

(57) ABSTRACT

In various implementations of the invention, methods and apparatuses are provided that enable timing accurate, bit level hardware models for simulation at a rapid rate. With various implementations of the invention, a functional module is combined with a timing module. The combination may be employed to assist in performing performance modeling. With various implementations of the invention, a functional module, a timing module, and a module wrapper are provided, the module wrapper having at least a slave and master port. The slave port and the master port allowing for the exchange of data between modules, between the module and a host computing environment, and between the module and a performance modeling platform.

### RELATED APPLICATIONS

This application claims priority to U.S. Provisional Patent Application No. 61/207,882 entitled “Programmer View Timing Model For Microdevice Designs,” filed on Jan. 30, 2009, and naming Yossi Veller et al. as inventors, which application is incorporated entirely herein by reference.

### FIELD OF THE INVENTION

The invention relates to the field of electronic system level design. More specifically, various embodiments of the invention relate to modeling of electronic device designs. Additionally, various embodiments of the invention relate to virtual prototyping employing electronic device design models.

### BACKGROUND OF THE INVENTION

### Electronic Device Design

Electronic devices, and particularly integrated circuits (IC's), are designed at various levels of abstraction. For example, designs often start at a high level of abstraction, by the designers creating a specification that describes particular desired functionality. This specification, typically implemented by a programming language such as for example the C or C++ programming language, describes at a very high level the desired behavior of the device. Designers will then often take this specification which may be executable, and create a logical design. This logical design is often referred to as a register transfer level (RTL) design.

A register transfer level design, often implemented by a hardware description language (HDL) such as Verilog or VHDL, describes the operation of the device by defining the flow of signals or the transfer of data between various hardware components within the design. More particularly, a register transfer level design describes the interconnection and exchange of signals between hardware registers and the logical operations that are performed on those signals. Once a register transfer level design is created, it is typically analyzed to confirm that it will accurately perform the functions called for in the specification. This verification is sometimes referred to as “functional verification.”

Once the accuracy of the logical design is confirmed, then it is typically converted into a gate level design. This gate level design describes the gates implemented by actual physical components such as transistors, capacitors, and resistors as well as the interconnections between these physical components. This gate level design is taken and again transformed into a layout design, which may be used to fabricate the electronic device.

Electronic design automation (EDA) tools are often employed to assist in the design flow. For example, synthesis tools may be employed to take a high level specification and generate a register transfer level description of the device. Additionally, verification tools are available that assist in verifying a register transfer level design accurately performs the functions defined by the specification. Furthermore, synthesis tools are available that take a logical design and generate gate level and corresponding layout designs. For example, electronic design automation tools, such as Catapult C Synthesis by Mentor Graphics Corporation, may be employed to transform an electronic system level design into a register transfer level design, and subsequently to a gate level implementation.

### Electronic System Level Design

Modern circuits have decreased in size exponentially. As a result, designers are able to add an increased number of circuit components into a given design. The ability to increase the amount of circuit components within a given design also allows for an increase in the functionality of the design. Even with this increased number of circuit components in a given design, it is still often possible for manufactures to shrink the size of the device. Armed with smaller circuits having increased functionality, designers have begun offering discrete electronic systems packaged on a single integrated circuit device, or “chip.” These discrete electronic systems are often referred to as a System-on-Chip (SOC).

System-on-Chip devices are prevalent in modern electronics, such as cell-phones, digital video disk (DVD) players, video game consoles, household appliances, automobiles, and telecommunications equipment. Typically, a System-on-Chip is composed of blocks specifically designed to perform a particular task. These blocks are all interconnected by some communication structure, such as a shared communication bus or even a Network-on-Chip (NoC). Most System-on-Chip designs also require some “software” or instructions executable by various blocks within the design in order to function. The System-on-Chip software, sometimes referred to as embedded software, provides designers the chance to increase the functionality of the design beyond that with which a hardware design alone is capable.

As modern designs contain both hardware and software, extra design steps are necessary to ensure the combination of software and hardware functions as intended.

Traditionally, the hardware portions of a device were designed, followed by the software portions of the device. After the hardware was finalized, a prototype of the hardware was manufactured so that the software could be tested with the prototype. Any necessary redesigns of hardware or software followed. In an effort to increases time to market and reduce development costs, designers began to concurrently design the hardware and software portions of a design. However, this has posed a problem for designers as a hardware implementation is not available for the software to be tested upon. Accordingly, during development designers often employ a model of the hardware as opposed to an actual implementation of the hardware. The testing of software on a hardware model of the system is often referred to as virtual prototyping.

As stated above, behavioral models are available in various levels of abstraction, for example, algorithmic models or register transfer level models. The designing and testing of devices at these varying levels of abstraction is often referred to as electronic system level (ESL) design.Models of a high level of abstraction have advantages over models of a low level of abstraction. For example, an algorithmic model, which may be written in C++, has a rapid simulation speed. However, only the algorithm is captured and none of the hardware implementation such as the logical operations of registers, or synchronization of the system is modeled. As a result, algorithmic models are unsuitable for execution of embedded software.

Models at a lower level of abstraction, for example the register transfer level, mimic the real hardware implementation with greater fidelity. These models having a low level of abstraction are often referred to as logical models. One drawback to using logical models in virtual prototyping is that the simulation time is significantly longer. This is due to the added computational overhead of more accurately simulating the hardware implementation. This longer simulation time only increases as modern designs increase in complexity. As a result it is computationally expensive to use logical models for virtual prototyping. Furthermore, in a typical modern design flow, the logical models are often not finished until the later design stages, which make it inconvenient to use logical models in virtual prototyping.

Due to the complications of using an algorithmic model or a logical model for virtual prototyping, designers will often employ a model having a balance between the speed of a high level model and the accuracy of a low level model. A common modeling technique that fits this need is referred to as transaction level modeling (TLM.) Transaction level models are typically written in a high level programming language such as SystemC. A transaction level model represents the hardware components of the design as modules. Each module has a set of predefined behaviors, often referred to as threads or processes. The modules exchange information or communicate in the form of transactions. Often, communication protocols are encapsulated in channels, having ports that facilitate the exchange of data. Transaction level models are discussed in greater detail below.

Transaction level models have many benefits. For example, transaction level models can be bit accurate. More particularly, the logical operations are accurately simulated even at the bit level. Additionally, transaction level models accurately represent the register and address space of the hardware, which makes them suitable candidates for virtual prototyping. Furthermore due to the fact that transaction level models may be written in a high level language, they are typically available earlier in the design flow than logical models are. Moreover, transaction level models simulate at a rapid rate and if they include timing they can be used for performance modeling, which may be used to evaluate various hardware architectures for the device design.

### SUMMARY OF THE INVENTION

In various implementations of the invention, a methods and apparatuses are provided that enable timing accurate, bit level hardware simulation. With various implementations of the invention, a functional module is combined with a timing module. The combination may be employed to assist in performing virtual prototyping. With various implementations of the invention, a functional module, a timing module, and a module wrapper are provided, the module wrapper having at least a slave or master port. The slave port and the master port allowing for the exchange of data between modules, between the module and a host computing environment, and between the module and a virtual prototyping platform.

In various implementations of the invention, a hardware design is modeled by a functional model and a timing model. The functional model describes actions or behaviors with which the hardware design may perform. The timing model describes performance characteristics associated with each action or behavior. The models are encapsulated in a wrapper, which includes slave port(s) and master port(s) that correspond to the ports of the functional model and the timing model. The wrapper may be implemented in a virtual prototyping system such that functioning of the hardware and or any interaction between the hardware and the software intended to be executed upon the hardware may be tested. More particularly, the model wrapper allows for the simulation of timing accurate behaviors without changing to the functional models.

### BRIEF DESCRIPTION OF THE DRAWINGS

The present invention will be described by way of illustrative embodiments shown in the accompanying drawings in which like references denote similar elements, and in which:

FIG. 1 illustrates a module representing a component within an electronic design;

FIG. 2 illustrates a modeling system employing the module illustrated in FIG. 1;

FIG. 3 illustrates a prior art transaction level modeling system;

FIG. 4 illustrates another prior art transaction level modeling system;

FIG. 5 illustrates an exemplary operating environment with which various embodiments of the present invention may implemented;

FIG. 6 illustrates a portion of the exemplary operating environment of FIG. 5, shown in greater detail;

FIG. 7 illustrates a transaction level modeling system that may be implemented according to various embodiments of the present invention;

FIG. 8 illustrates a module wrapper from a transaction level modeling system that may be implemented according to various embodiments of the present invention;

FIG. 9 illustrates a method of processing transactions according to various implementations of the invention;

FIG. 10 illustrates the method of processing transaction of FIG. 9 in further detail; and

FIG. 11 illustrates a method of processing transactions according to various implementations of the invention.

### DETAILED DESCRIPTION OF ILLUSTRATIVE EMBODIMENTS

### Transaction Level Modeling

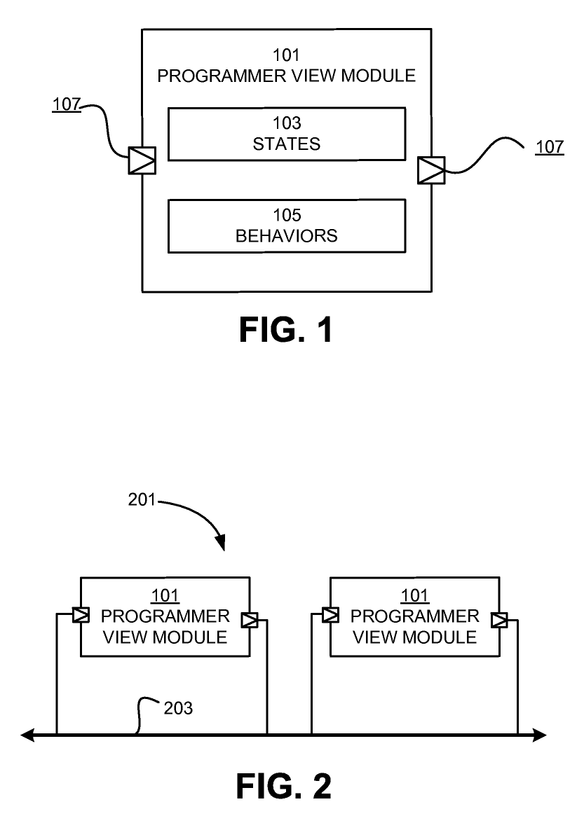

As introduced above, transaction level modeling is a technique for performing virtual prototyping, which may include performance modeling. Transaction level modeling is typically facilitated by employing models having a higher level of abstraction than logical models. Typically, transaction level modeling methodologies employ two types of models. An “untimed” and a “timed” model. The “untimed” model represents the behavioral characteristics of the hardware implementation while the “timed” model represents the behavioral characteristics and the performance characteristics of the hardware implementation. Typically, individual models, referred to as modules, are generated to represents each component within the hardware design. In a digital electronic system, each component is composed of a finite set of available states and a series of concurrent behaviors. Accordingly, a module representing the component must accurately represent these states and behaviors. FIG. 1 illustrates a module 101, which may be employed to represent a component of a hardware design in a transaction level modeling system. The module 101 includes a set of states 103 and a set of behaviors 105. Furthermore, as can be seen in FIG. 1, the module 101 includes ports 107. Suppose the module 101 illustrated in FIG. 1 represented an inverter. The set of states 103 would then include a logical “1” and a logical “0”. The set of behaviors 105 would then include a process to set the current state as the compliment of any state on the input port 107. The behaviors 105 are often referred to as concurrent processes or threads. Furthermore, as the module 101 represents the behavior of the component, it is often referred to as a behavioral model, functional model, or programmer view (PV) model.

FIG. 2 illustrates a modeling system 201 employing a plurality of the modules 101 illustrated in FIG. 1. As can be seen, the modeling system 201 may be formed by connecting a plurality of modules 101. Each one of the modules 101 may represent a selected component within the design. Communication or the exchange of data between the modules 101 is facilitated by the ports 107. The particular set of data exchanged between modules is often referred to as a transaction. The ports 107 may be connected through a specific communication structure 203, such as for example a bus or a communication channel. Alternatively, the ports 107 may be directly connected to each other.

Real world digital electronic designs have various timing constraints, such as for example delays associated with reading data from a memory storage register.

Additionally, as discussed above, in order to accurately perform performance modeling and virtual prototyping, the timing of a particular hardware implementation must also be modeled. However, modules, such as the module 101, are written in a high level programming language and therefore do not account for the timing characteristics of a particular hardware implementation. Accordingly, as stated above, a transaction level modeling methodology will typically include models that add timing characteristics to each transaction. These models are often referred to as bus models.

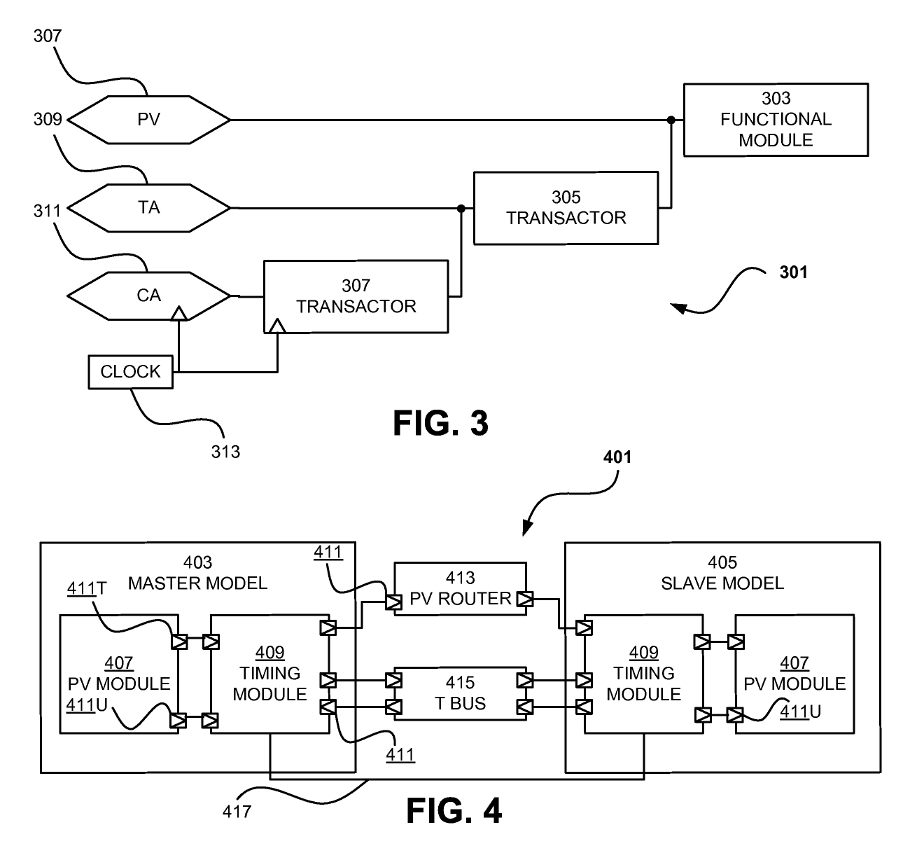

FIG. 3 illustrates a prior art transaction level modeling methodology 301, which may be implemented using the module and modeling system illustrated in FIG. 1 and FIG. 2. As can be seen in FIG. 3, the methodology 301 includes a functional module 303, as well as a first transactor 305 and a second transactor 307.The methodology 301 may be implemented with a programmer view bus 307, a timing approximate bus 309, or a cycle accurate bus 311. As can be seen, the cycle accurate bus 311 is connected directly to the clock 313 and models the hardware implementations accurately for each clock cycle. The transactor 307 may be employed to add timing characteristics to the timing approximate bus 309.

Additionally, the transactor 307 may be employed in conjunction with the transactor 305 to add timing characteristics to the programmer view bus 307. Although the methodology 301 will not typically be implemented with all three of the busses 307 through 311 at once, it is helpful to visualize them together as FIG. 3 illustrates.

Transaction level methodologies similar to the methodology 301 have many disadvantageous. For example, the functional module 303 responds to each transaction in blocks. As a result, the functional module 303 operates at slow rates of speed, which increases the time required to perform virtual prototyping. Additionally, in order to get some fidelity with respect to the timing characteristics of the hardware design, the functional module 303 will typically need to have a lower level of abstraction, which has the disadvantage of longer simulation and development times as well as the need to change the models based upon the hardware implementation.

The methodology 301 contains a clear separation between the behavioral models, such as the functional module 303, and the timing, such as the transactor 305 and the transactor 307. However, the interface between the timing and the behavioral models is not well defined. For example, various prior art methodologies similar to the methodology 301 specify that the actual value of the timing parameters may either be a constant, a data dependent variable, or may be drawn from a stochastic distribution function. As a result, it is difficult to separate the behavioral models for the timing. More particularly, the behavioral model, such as the functional module 303, must call the timing code, such as the transactor 305, in order to evaluate the timing of different functional operations. This requires the behavioral module to pause execution of the software being verified for a specified time or pass the time parameter to another part of the design, where execution would be paused for the specified time. As a result, timing effects that relate to pipelining can not be modeled accurately with transaction level modeling methodologies similar to the methodology 301.

Additional disadvantages of the methodology 301 are that the transactor 305 or the transactor 307 can not accurately account for modern memory access processes, such as a direct memory access process. Furthermore, timing simulation typically requires one or two transactors per port, which means at least a thread per port. Thus the number of threads required for this type of methodology may be two or three times the number of the treads required for the model. As a result, the time required to perform the transaction level modeling simulation increases.

FIG. 4 illustrates another prior art transaction level modeling methodology 401. As can be seen in FIG. 4, the methodology 401 includes a master model 403 and a slave model 405. The master model 403 and the slave model 405 each comprise a programmer view module 407 and a timing module 409. As detailed above, the programmer view modules 407 are composed of states and threads, while the timing modules 409 include performance characteristics for the model. Ports 411, as well as a programmer view router 413 and a timing bus 415 are employed to communicate between the master model 403 and the slave model 405. Additionally, the timing modules 409 use the ports 411 to capture transactions from the programmer view modules 407 and insert delays into the processing or sending of the transactions. Transactions may be exchanged through both timed ports 411T and untimed ports 411U. Synchronization between timed simulations and untimed simulations is accomplished by synchronization points or through the use of an interrupt 417.

In the methodology 401, the master model 403 initiates transactions with the slave model 405. As the programmer view modules 407 within the master and slave models 403 and 405 are high level models, the transactions execute in “zero simulation time.” More particularly, the execution is extremely fast. Synchronization points are employed within the simulation to synchronize the functional models and add timing characteristics to the simulation. When a synchronization point is reached, execution is passed to the timing modules 409. The timing modules 409 will then start simulating the delays associated with the computations and synchronization of the threads executed by the programmer view modules 407. Once all the relevant delays have been simulated, the programmer view modules 407 will resume execution until the next synchronization point. Further details of the methodology 401 may be found in “Transaction Level Modeling,” Laurent Maillet-Contoz et al., Transaction Level Modeling With SystemC, Chapter 2, Springer, 2005, which chapter is incorporated entirely herein by reference.

Although the prior art methodology 401 has some advantageous over the prior art methodology 301, there are still many drawbacks to implementing a transaction level modeling methodology similar to the methodology 401. For example, the need to treat asynchronous events requires modification to the functional models such that they are compatible with a methodology like the methodology 401. These modifications reduce the simulation speed of the functional models. An additional disadvantage to the prior art methodology 401 is that all communication with the behavioral modules occurs through the timing modules. For example, the programmer view modules 407 communicate through the timing modules 409. This adds significant computational overhead to the simulation. This additional computational overhead even exists for cases where the timing modules 409 are inactive.

### Exemplary Operating Environment

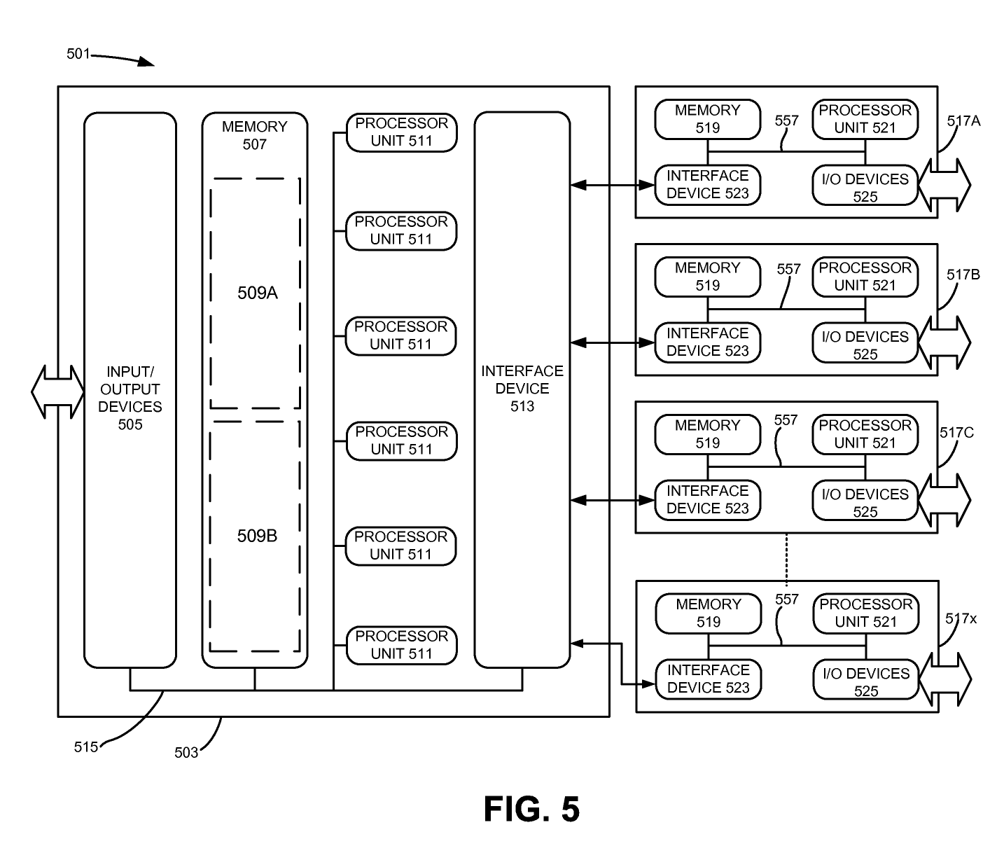

As stated above, various electronic design automation tools or processes may be implemented using computer executable software instructions executed by one or more programmable computing devices. Because these examples of the invention may be implemented using software instructions, the components and operation of a generic programmable computer system on which various embodiments of the invention may be employed is described. Further, because of the complexity of some electronic design automation processes and the large size of many circuit designs, various electronic design automation tools are configured to operate on a computing system capable of simultaneously running multiple processing threads. The components and operation of a computer network 501 having a host or master computer and one or more remote or slave computers therefore will be described with reference to FIG. 5. This operating environment is only one example of a suitable operating environment, however, and is not intended to suggest any limitation as to the scope of use or functionality of the invention.

In FIG. 5, the computer network 501 includes a master computer 503. In the illustrated example, the master computer 503 is a multi-processor computer that includes a plurality of input and output devices 505 and a memory 507. The input and output devices 505 may include any device for receiving input data from or providing output data to a user. The input devices may include, for example, a keyboard, microphone, scanner or pointing device for receiving input from a user. The output devices may then include a display monitor, speaker, printer or tactile feedback device. These devices and their connections are well known in the art, and thus will not be discussed at length here.

The memory 507 may similarly be implemented using any combination of computer readable media that can be accessed by the master computer 503. The computer readable media may include, for example, microcircuit memory devices such as random access memory (RAM), read-only memory (ROM), electronically erasable and programmable read-only memory (EEPROM) or flash memory microcircuit devices, CD-ROM disks, digital video disks (DVD), or other optical storage devices. The computer readable media may also include magnetic cassettes, magnetic tapes, magnetic disks or other magnetic storage devices, punched media, holographic storage devices, or any other medium that can be used to store desired information. As will be discussed in detail below, the master computer 503 runs a software application for performing one or more operations according to various examples of the invention. Accordingly, the memory 507 stores software instructions 509A that, when executed, will implement a software application for performing one or more operations. The memory 507 also stores data 509B to be used with the software application. In the illustrated embodiment, the data 509B contains process data that the software application uses to perform the operations, at least some of which may be parallel.

The master computer 503 also includes a plurality of processor units 511 and an interface device 513. The processor units 511 may be any type of processor device that can be programmed to execute the software instructions 509A, but will conventionally be a microprocessor device. For example, one or more of the processor units 511 may be a commercially generic programmable microprocessor, such as Intel® Pentium® or Xeon™ microprocessors, Advanced Micro Devices Athlon™ microprocessors or Motorola 68K/Coldfire® microprocessors. Alternately or additionally, one or more of the processor units 511 may be a custom manufactured processor, such as a microprocessor designed to optimally perform specific types of mathematical operations. The interface device 513, the processor units 511, the memory 507 and the input/output devices 505 are connected together by a bus 515.

With some implementations of the invention, the master computing device 503 may employ one or more processing units 511 having more than one processor core.

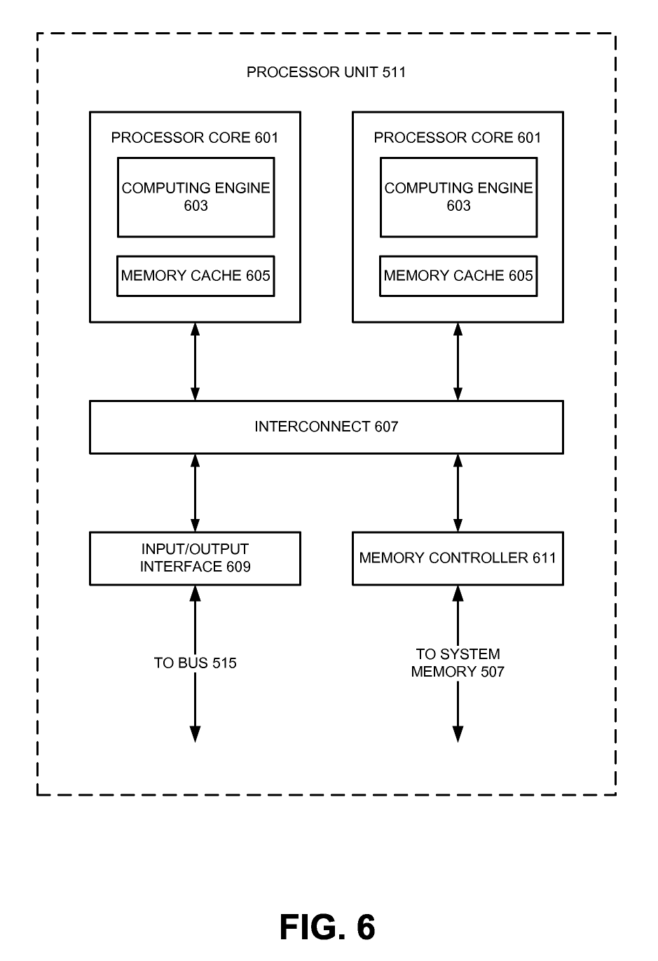

Accordingly, FIG. 6 illustrates an example of a multi-core processor unit 511 that may be employed with various embodiments of the invention. As seen in this figure, the processor unit 511 includes a plurality of processor cores 601. Each processor core 601 includes a computing engine 603 and a memory cache 605. As known to those of ordinary skill in the art, a computing engine contains logic devices for performing various computing functions, such as fetching software instructions and then performing the actions specified in the fetched instructions. These actions may include, for example, adding, subtracting, multiplying, and comparing numbers, performing logical operations such as AND, OR, NOR and XOR, and retrieving data. Each computing engine 603 may then use its corresponding memory cache 605 to quickly store and retrieve data and/or instructions for execution.

Each processor core 601 is connected to an interconnect 607. The particular construction of the interconnect 607 may vary depending upon the architecture of the processor unit 601. With some processor cores 601, such as the Cell microprocessor created by Sony Corporation, Toshiba Corporation and IBM Corporation, the interconnect 607 may be implemented as an interconnect bus. With other processor cores 601, however, such as the Opteron™ and Athlon™ dual-core processors available from Advanced Micro Devices of Sunnyvale, Calif., the interconnect 607 may be implemented as a system request interface device. In any case, the processor cores 601 communicate through the interconnect 607 with an input/output interfaces 609 and a memory controller 611. The input/output interface 609 provides a communication interface between the processor unit 511 and the bus 515. Similarly, the memory controller 611 controls the exchange of information between the processor unit 511 and the system memory 507. With some implementations of the invention, the processor units 511 may include additional components, such as a high-level cache memory accessible shared by the processor cores 601.

While FIG. 6 shows one illustration of a processor unit 511 that may be employed by some embodiments of the invention, it should be appreciated that this illustration is representative only, and is not intended to be limiting. For example, some embodiments of the invention may employ a master computer 503 with one or more Cell processors. The Cell processor employs multiple input/output interfaces 609 and multiple memory controllers 611. Also, the Cell processor has nine different processor cores 601 of different types. More particularly, it has six or more synergistic processor elements (SPEs) and a power processor element (PPE). Each synergistic processor element has a vector-type computing engine 503 with 128×128 bit registers, four single-precision floating point computational units, four integer computational units, and a 256 KB local store memory that stores both instructions and data. The power processor element then controls that tasks performed by the synergistic processor elements. Because of its configuration, the Cell processor can perform some mathematical operations, such as the calculation of fast Fourier transforms (FFTs), at substantially higher speeds than many conventional processors.

It also should be appreciated that, with some implementations, a multi-core processor unit 511 can be used in lieu of multiple, separate processor units 511. For example, rather than employing six separate processor units 511, an alternate implementation of the invention may employ a single processor unit 511 having six cores, two multi-core processor units 511 each having three cores, a multi-core processor unit 511 with four cores together with two separate single-core processor units 511, or other desired configuration.

Returning now to FIG. 5, the interface device 513 allows the master computer 503 to communicate with the slave computers 517A, 517B, 517C . . . 517x through a communication interface. The communication interface may be any suitable type of interface including, for example, a conventional wired network connection or an optically transmissive wired network connection. The communication interface may also be a wireless connection, such as a wireless optical connection, a radio frequency connection, an infrared connection, or even an acoustic connection. The interface device 513 translates data and control signals from the master computer 503 and each of the slave computers 517 into network messages according to one or more communication protocols, such as the transmission control protocol (TCP), the user datagram protocol (UDP), and the Internet protocol (IP). These and other conventional communication protocols are well known in the art, and thus will not be discussed here in more detail.

Each slave computer 517 may include a memory 519, a processor unit 521, an interface device 523, and, optionally, one more input/output devices 525 connected together by a system bus 527. As with the master computer 503, the optional input/output devices 525 for the slave computers 517 may include any conventional input or output devices, such as keyboards, pointing devices, microphones, display monitors, speakers, and printers. Similarly, the processor units 521 may be any type of conventional or custom-manufactured programmable processor device. For example, one or more of the processor units 521 may be commercially generic programmable microprocessors, such as Intel® Pentium® or Xeon™ microprocessors, Advanced Micro Devices Athlon™ microprocessors or Motorola 68K/Coldfire® microprocessors. Alternately, one or more of the processor units 521 may be custom manufactured processors, such as microprocessors designed to optimally perform specific types of mathematical operations. Still further, one or more of the processor units 521 may have more than one core, as described with reference to FIG. 6 above. For example, with some implementations of the invention, one or more of the processor units 521 may be a Cell processor. The memory 519 then may be implemented using any combination of the computer readable media discussed above. Like the interface device 513, the interface devices 523 allow the slave computers 517 to communicate with the master computer 503 over the communication interface.

In the illustrated example, the master computer 503 is a multi-processor unit computer with multiple processor units 511, while each slave computer 517 has a single processor unit 521. It should be noted, however, that alternate implementations of the invention may employ a master computer having single processor unit 511. Further, one or more of the slave computers 517 may have multiple processor units 521, depending upon their intended use, as previously discussed. Also, while only a single interface device 513 or 523 is illustrated for both the master computer 503 and the slave computers 517, it should be noted that, with alternate embodiments of the invention, either the master computer 503, one or more of the slave computers 517, or some combination of both may use two or more different interface devices 513 or 523 for communicating over multiple communication interfaces.

With various examples of the invention, the master computer 503 may be connected to one or more external data storage devices. These external data storage devices may be implemented using any combination of computer readable media that can be accessed by the master computer 503. The computer readable media may include, for example, microcircuit memory devices such as random access memory (RAM), read-only memory (ROM), electronically erasable and programmable read-only memory (EEPROM) or flash memory microcircuit devices, CD-ROM disks, digital video disks (DVD), or other optical storage devices. The computer readable media may also include magnetic cassettes, magnetic tapes, magnetic disks or other magnetic storage devices, punched media, holographic storage devices, or any other medium that can be used to store desired information. According to some implementations of the invention, one or more of the slave computers 517 may alternately or additions be connected to one or more external data storage devices. Typically, these external data storage devices will include data storage devices that also are connected to the master computer 503, but they also may be different from any data storage devices accessible by the master computer 503.

It also should be appreciated that the description of the computer network illustrated in FIG. 5 and FIG. 6 is provided as an example only and is not intended to suggest any limitation as to the scope of use or functionality of alternate embodiments of the invention.

### Programmer View Timing Model

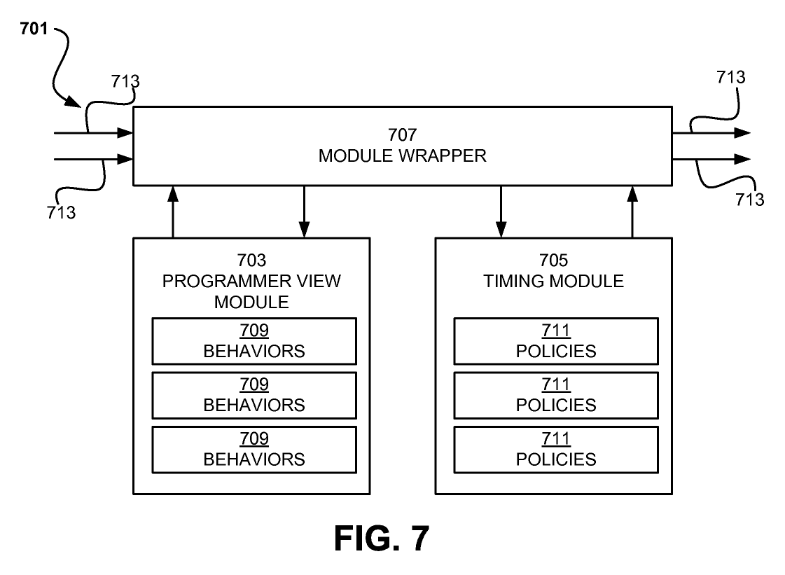

FIG. 7 illustrates a transaction level modeling methodology 701 that may be implemented according to various embodiments of the present invention. The methodology 701 includes a programmer view module 703, a timing module 705 and a module wrapper 707. As can be seen from FIG. 7, the programmer view module 703 includes a plurality of behaviors 709. The behaviors 709 specify particular transactions that may be executed by the module 703. In various implementations of the invention, the programmer view module 703 is a high level model, for example a functional model written in SystemC.

The timing module 705 includes a plurality of policies 711. As the timing module 705 represents the performance or timing characteristics of the system, the timing modules 705 are often referred to as performance modules or performance models. The policies 711 define processes for generating timing transactions corresponding to the transactions of the programmer view module 703. In various implementations of the invention, the policies are declarative language, executable by a computer, for generating timing transactions that correspond to particular behavioral transactions. In various implementations of the invention, the policies may be enhanced with a “mid-level” programming language such as for example C++. As stated, the policies 711 define timing constraints associated with various transactions 709. For example, a policy 711 may define a latency associated with a particular transaction. Additionally, the policy may define a latency associated with a particular transaction arriving at a particular slave or target port.

With various implementations of the invention, a policy 711 may define causality and timing relationships between the start or end event of a first transaction and the start of a second transaction. For example, a policy 711 that specifies a read-end on a first port may be followed by an interrupt on a second port and an associated time delay may be defined. In various implementations of the invention, the policy 711 would not necessarily specify that the interrupt must follow the write, merely that it may. Still, in various implementations of the invention, the behavior 709 within the programmer view module 703 may specify when the interrupt would follow the write. The first transaction is often referred to herein as the cause transaction, while the second transaction is often referred to herein as the effect transaction. In various implementations of the invention, the cause transaction and the effect transaction are different transactions. With various implementations, the cause transaction and the effect transaction are the same transaction.

As stated above, a module, such as the programmer view module 703 may be representative of a single component within a hardware design. Accordingly, the module wrapper 707 would also be representative of the same single component. To facilitate simulation of data exchanges between various components within a hardware design, the module wrapper 707 includes ports 713 for communication between other module wrappers. With various implementations of the invention, a programmer view module 703 is representative of a block of components. For example, a programmer view module 703 may represent a digital to analog converter. Accordingly, a module wrapper 707 encapsulating this programmer view module 703 would represent the digital to analog converter. Still, with various implementations of the invention, a programmer view module 703 and associated module wrapper 707 represents a plurality of components within the device.

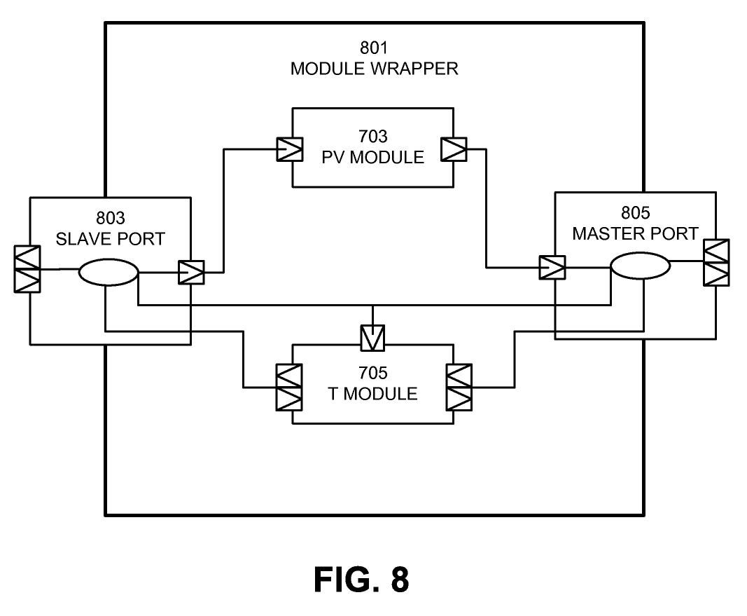

FIG. 8 illustrates a module wrapper 801, which may be implemented according to various embodiments of the present invention. As can be seen from FIG. 8, the module wrapper 801 comprises the programmer view module 703 and the timing module 705. Additionally, the module wrapper 801 includes a slave port 803 and a master port 805. In various implementation of the invention, the module wrapper 801 may be implemented in a transaction level modeling methodology, such as the methodology 701 illustrated in FIG. 7.

### Illustrative Timing Policies

In various implementations of the invention, a timing policy 711 having associated wait states may be defined for the slave port 803. The wait states parameter is typically used to represent the added latency of the model per data word for a transaction on this port. For example, a memory write request to a register may involve a clock cycle for arbitration of the write request, a clock cycle for passing a word, and a number of additional “wait” clock cycles. The first two clocks cycles are artifacts of the communication protocol while the additional “wait” clock cycles may be defined by the timing policy 711.

With various implementations of the invention, a timing policy 711 may be defined for the master port 805. This timing policy 711 may specify how slave transactions are split into timing transaction sequences, often referred to as bursts. Accordingly, this type of timing policy 711 is often referred to as a split timing policy. A split timing policy may have two parameters, latency and burst size. With various implementations of the invention, latency is the minimum allowed time between bursts. The burst size corresponds to the maximum size of the output buffer of the model. This output buffer constrains the size of the bursts that can be issued on the port. For example, the communication protocol or channel used by a port may impose other constraints such as data size restrictions or addressing restrictions.

With still, with various implementations of the invention, a timing policy 711 which specifies that the start of a selected type of transaction may follow the end of another selected type of transaction may be defined. This type of timing policy 711 is often referred to as a sequential timing policy. For example, an interrupt on one port may follow the end of a write sequence on another port. The sequential timing policy often has one parameter, latency. Latency represents the delay between the two timing transactions. For example, when a write sequence ends on a first port, the timing module may issue an interrupt on another port after the appropriate time delay.

Further still, various implementations of the invention, a timing policy 711 may be defined to allow pipelining of transactions. This type of timing policy 711 is often referred to as a pipeline timing policy. A pipeline timing policy is similar to the sequential timing policy, except that the second timing transaction sequence follows the start of the first timing transaction sequence. More particularly, the pipeline timing policy specifies that a selected type of transaction may begin once another selected type of transaction has begun. The pipeline timing policy has two parameters, data delay and latency. The data delay represents the number of bytes of a transaction the module should receive before it is ready to begin generating the output transaction and is often referred to as the pipeline depth. The latency specifies a time that should elapse after this point. For example, the pipeline timing policy may specify that the output of a finite impulse response filter should follow the start of its input once the pipeline depth is reached with zero latency.

### Module Wrapper Transaction Processing

As stated above, a transaction level modeling methodology, such as the methodology 701 illustrated in FIG. 7 may be provided with at least a module wrapper and a behavioral module and a performance module. Typically, a module wrapper will encompass a plurality of behavioral modules and a plurality of performance modules. For example, the module wrapper 801 illustrated in FIG. 8 may be provided in various implementations of the invention. As further stated above, a transaction level modeling methodology according to various implementations of the invention may be employed to perform virtual prototyping. Additionally, a transaction level modeling methodology according to various implementations of the invention may be employed to perform performance modeling.

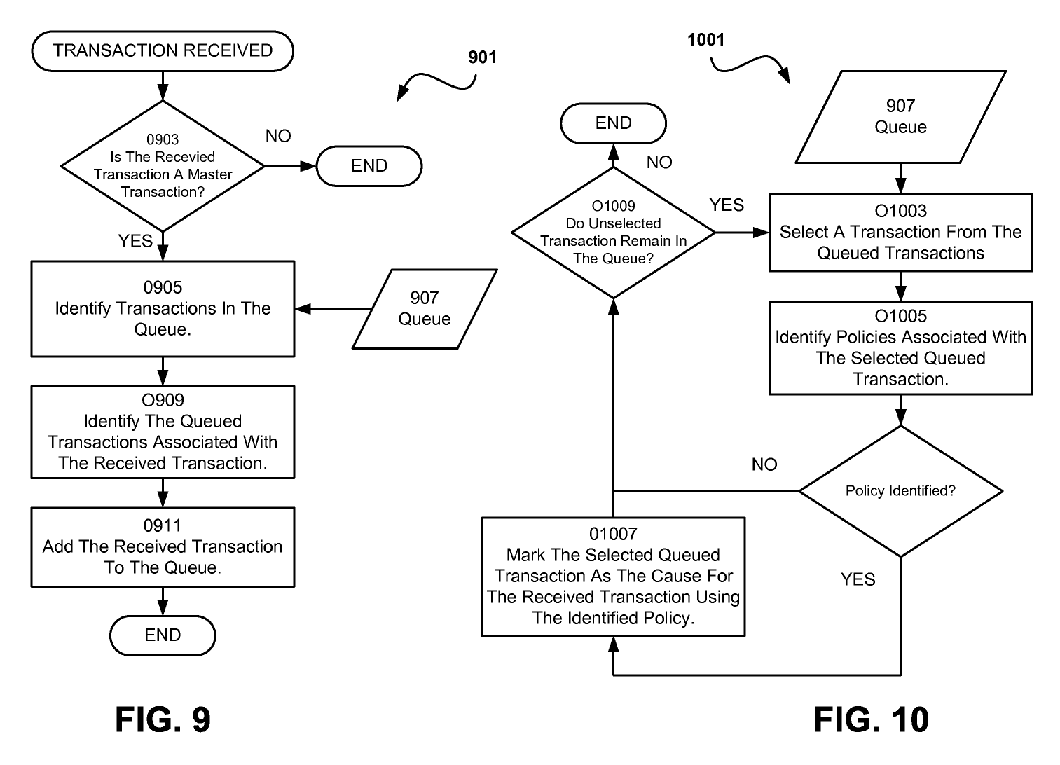

FIG. 9 illustrates a method of processing transactions 901 that may be provided with various implementations of the present invention. The method 901 may be implemented by a module wrapper, such as the module wrapper 801 shown in FIG. 8. For example, the module wrapper 801 may further include a policy engine (not shown) that may perform the method 901 illustrated in FIG. 9. As can be seen from this figure, the method 901 begins when a transaction is received. In various implementations of the invention, a transaction is received when it is identified by the module wrapper. With further implementations, a transaction is identified when it is received on a port of the module wrapper. With various implementations, a transaction is identified when it is received from the behavioral portion of the module wrapper, such as for example the programmer view module 703. The method 901 includes an operation 903 for determining if the received transaction is a master transaction, an operation 905 for identifying transactions in a queue 907, an operation 909 for identifying transactions in the queue 907 associated with the received transaction, and an operation 911 for adding the received transaction to the queue 907. In various implementations o the invention, the operation 909 identifies policies associated with the queued transaction according to the method 1001 illustrated in FIG. 10.

As can be seen from this figure, the method 1001 includes an operation 1003 for selecting a transaction from the transactions in the queue 907 and an operation 1005 for identifying policies associated with the selected queued transaction. In various implementations of the invention, the operation 1005 will identify a policy as associated with the selected queued transaction if according to the policy, the selected queued transaction can be a cause for the policy and the received transaction can be an effect of the policy. More particularly, the operation 1005 may determine if the selected queued transaction can be a cause for the received transaction. The method 1001 further includes an operation 1007 for marking the selected queued transaction as the cause for the received transaction if a policy was identified by the operation 1005. Additionally as can be seen from this figure, the method 1001 is repeated for unselected transaction in the queue 907.

As stated, the method 901 of FIG. 9 may be performed by module wrapper 801.

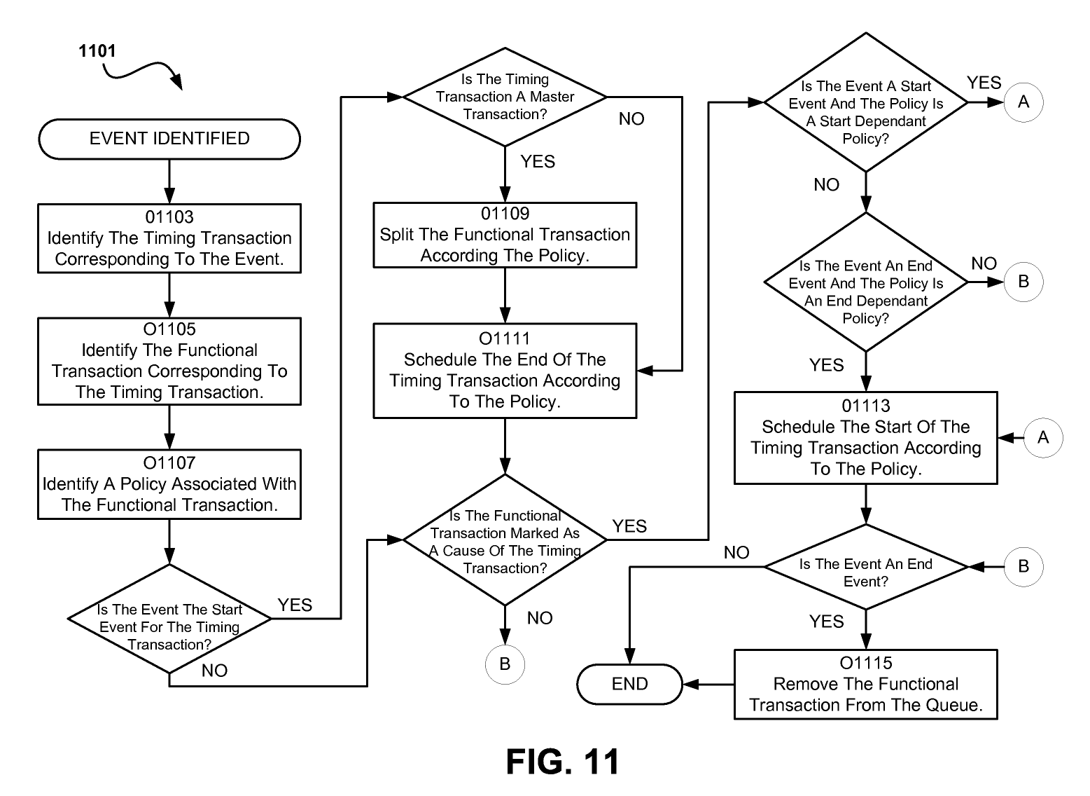

FIG. 11 illustrates a method 1101 that may be provided by various implementations of the invention and be performed by the module wrapper in addition or in the alternative to the method 901. As can be seen from FIG. 11, the method 1101 begins when an event is identified. In various implementations of the invention an event is identified when it is either the start or end of a timing transaction. The method 1101 includes an operation 1103 for identifying the timing transaction corresponding to the event, an operation 1105 for identifying the functional transaction corresponding to the identified timing transaction, and an operation 1107 for identifying a policy associated with the functional transaction. In various implementations of the invention, the functional transaction is identified from a queue of transactions.

The method 1101 further includes an operation 1109 for splitting the functional transaction according to the policy if the event is the start event for the timing transaction and the timing transaction is a master transaction as well as an operation 1111 for scheduling the end of the timing transaction if the event is the start event for the timing transaction. For example, as stated earlier, functional transactions represent behaviors of the device under test, policies are employed to generate timing transactions corresponding to the various functional transactions and these various transactions have events that correspond to the transaction. Accordingly, a module wrapper, such as for example the module wrapper 801, may employ the method 1101 to process the identification or reception of transactions and events for implementation in a virtual prototyping environment.

As can be further seen from FIG. 11, the method 1101 additionally includes an operation 1111 for scheduling the start of the timing transaction according to the policy if the functional transaction is marked as the cause of the timing transaction and either the event is a start event and the policy is a start dependant policy or the event is an end event and the policy is an end dependant policy. In various implementations of the invention, the policy specifies whether the functional transaction is the cause of the timing transaction. Furthermore, the method 1101 includes an operation 1115 for removing the functional transaction from the queue of transactions if the event is an end event.

### Programmer View Timing Model Synchronization

As stated above, simulation on functional models is untimed, and operates essentially in “zero simulation time,” while timing simulation consumes simulation time.

Logically, it would seem that these two layers of simulation could operate independently. As a result, synchronization between the functional simulation and the timing simulation may not happen. However, modern hardware and software contain asynchronous processes or events, which require synchronization points to align the their execution.

In various implementations of the invention, an interrupt can function as a synchronization point. For example, a functional module, such as the programmer view module 703, may wait on an interrupt slave port. More particularly, a timing transaction may trigger an interrupt causing the functional module waiting for the interrupt to be triggered. With various implementations of the invention, polling mechanisms may be employed also as synchronization points. For example, a functional module may loop until a register or other object changes. The loop procedure will typically includes a wait statement in order to allow other process(es) to execute and change the value of the object. Still, with various implementations of the invention, a blocking interface may be employed to synchronize the simulation. For example, functional statements that simply consume time may be executed and cause the timing modules to execute.

### Conclusion

As disclosed, various implementations of the invention provide methods and apparatuses that enable timing accurate, bit level hardware simulation as a rapid rate. With various implementations of the invention, a functional module is combined with a timing module. The combination may be employed to assist in performing performance modeling. With various implementations of the invention, a functional module, a timing module, and a module wrapper are provided. The module wrapper having at least a slave or a master port. The slave port and the master port allowing for the exchange of data between modules.

In various implementations of the invention, a hardware design is modeled by a functional model and a timing model. The functional model describes actions or behaviors with which the hardware design may perform. The timing model describes performance characteristics associated with each action or behavior. The models are encapsulated in a wrapper, which includes slave port(s) and master port(s). The model wrapper allows for the simulation of timing accurate behaviors without change to the functional models.

Although certain devices and methods have been described above in terms of the illustrative embodiments, the person of ordinary skill in the art will recognize that other embodiments, examples, substitutions, modifications and alterations are possible. It is intended that the following claims cover such other embodiments, examples, substitutions, modifications and alterations within the spirit and scope of the claims.

What is claimed is:

1. A computer program product for scheduling timing transactions associated with a functional model comprising:
software instructions for enabling a computer to perform a set of predetermined operations; and
a computer readable storage medium bearing the software instructions,
the set of predetermined operations including:
identifying a first module, the first module comprising at least one behavior;
identifying a second module, the second module comprising at least one timing policy;
instantiating both the first module and the second module through a module wrapper; and
scheduling a transaction by the module wrapper,
the scheduling based in part upon one of the at least one timing policies, and
the transaction corresponding to one of the at least one behaviors.

2. The computer program product recited in claim 1, each of the at least one behaviors corresponding to at least one transaction.

3. The computer program product recited in claim 2, each of the at least one timing policies describing a timing characteristic associated with at least one of the at least one transactions.

4. The computer program product recited in claim 3, the predetermined operation for scheduling the transaction by the module wrapper comprising:
identifying an event,
the event implicating the transaction, and
the transaction being a timing transaction;
identifying a functional transaction, the functional transaction corresponding to the timing transaction;
identifying a policy associated with the functional transaction; and
scheduling the timing transaction based in part upon the policy.

5. The computer program product recited in claim 4, the predetermined operation for scheduling the transaction by the module wrapper further comprising splitting the functional transaction into a plurality of sub-transactions based in part upon the policy.

6. The computer program product recited in claim 5, the predetermined operation for splitting the second transaction into a plurality of sub-transactions based in part upon the policy comprising:
determining if the event implicates the start of the timing transaction;
determining if the timing transaction is a master transaction; and
splitting the functional transaction into a plurality of sub-transactions if,
it is determined that the event implicates the start of the timing transaction, and
it is determined that the timing transaction is a master transaction.

7. The computer program product recited in claim 6, the predetermined operation for scheduling the timing transaction based in part upon the policy comprising scheduling the end of the transaction if it is determined that the event implicates the start of the timing transaction.

8. The computer program product recited in claim 4, the predetermined operation for scheduling the timing transaction based in part upon the policy comprising:
determining if the functional transaction is a cause of the timing transaction;
determining if the event implicates the start of the timing transaction;
determining if the policy is a start dependant policy; and
scheduling the start of the timing transaction if,
it is determined that the functional transaction is a cause of the timing transaction, and
it is determined that the event implicates the start of the timing transaction, and
it is determined that the policy is a start dependant policy.

9. The computer program product recited in claim 4, the predetermined operation for scheduling the timing transaction based in part upon the policy comprising:
determining if the functional transaction is a cause of the timing transaction;
determining if the event implicates the end of the timing transaction;
determining if the policy is an end dependant policy; and
scheduling the start of the timing transaction if,
it is determined that the functional transaction is a cause of the timing transaction, and
it is determined that the event implicates the end of the timing transaction, and
it is determined that the policy is an end dependant policy.

10. The computer program product recited in claim 4, wherein the policy is one of the at least one timing policies.

11. The computer program product recited in claim 3, the predetermined operation for scheduling the transaction by the module wrapper comprising:
identifying an event,
the event implicating the transaction, and
the transaction being a timing transaction;
identifying a functional transaction corresponding to the timing transaction from a queue of functional transactions;
determining if the event is an end event; and
removing the functional transaction from the queue of functional transactions if it is determined that the event is an end event.

12. A method for scheduling timing transactions associated with a functional model comprising:
identifying a first module, the first module comprising at least one behavior;
identifying a second module, the second module comprising at least one timing policy;
instantiating both the first module and the second module through a module wrapper; and
scheduling a transaction by the module wrapper,
the scheduling based in part upon one of the at least one timing policies, and
the transaction corresponding to one of the at least one behaviors.

13. The method recited in claim 12, each of the at least one behaviors corresponding to at least one transaction.

14. The method recited in claim 13, each of the at least one timing policies describing a timing characteristic associated with at least one of the at least one transactions.

15. The method recited in claim 14, the method act for scheduling the transaction by the module wrapper comprising:
identifying an event,
the event implicating the transaction, and
the transaction being a timing transaction;
identifying a functional transaction, the functional transaction corresponding to the timing transaction;
identifying a policy associated with the functional transaction; and
scheduling the timing transaction based in part upon the policy.

16. The method recited in claim 15, the method act for scheduling the transaction by the module wrapper further comprising splitting the functional transaction into a plurality of sub-transactions based in part upon the policy.

17. The method recited in claim 17, the method act for splitting the second transaction into a plurality of sub-transactions based in part upon the policy comprising:
determining if the event implicates the start of the timing transaction;
determining if the timing transaction is a master transaction; and
splitting the functional transaction into a plurality of sub-transactions if,
it is determined that the event implicates the start of the timing transaction, and
it is determined that the timing transaction is a master transaction.

18. The method recited in claim 17, the method act for scheduling the timing transaction based in part upon the policy comprising scheduling the end of the transaction if it is determined that the event implicates the start of the timing transaction.

19. The method recited in claim 15, the method act for scheduling the timing transaction based in part upon the policy comprising:
determining if the functional transaction is a cause of the timing transaction;
determining if the event implicates the start of the timing transaction;
determining if the policy is a start dependant policy; and
scheduling the start of the timing transaction if,
it is determined that the functional transaction is a cause of the timing transaction, and
it is determined that the event implicates the start of the timing transaction, and
it is determined that the policy is a start dependant policy.

20. The method recited in claim 15, the method act for scheduling the timing transaction based in part upon the policy comprising:
determining if the functional transaction is a cause of the timing transaction;
determining if the event implicates the end of the timing transaction;
determining if the policy is an end dependant policy; and
scheduling the start of the timing transaction if,
it is determined that the functional transaction is a cause of the timing transaction, and
it is determined that the event implicates the end of the timing transaction, and
it is determined that the policy is an end dependant policy.

21. The method recited in claim 15, wherein the policy is one of the at least one timing policies.

22. The method recited in claim 14, the method act for scheduling the transaction by the module wrapper comprising:
identifying an event,
the event implicating the transaction, and
the transaction being a timing transaction;
identifying a functional transaction corresponding to the timing transaction from a queue of functional transactions;
determining if the event is an end event; and
removing the functional transaction from the queue of functional transactions if it is determined that the event is an end event.

23. A computer program product for processing transactions generated by a virtual prototyping environment comprising:
software instructions for enabling a computer to perform a set of predetermined operations; and
a computer readable storage medium bearing the software instructions,
the set of predetermined operations including:
identifying a first transaction;
identifying a transaction queue, the transaction queue having at least one enqueued transaction;
enqueueing the first transaction into the transaction queue;
determining if the first transaction is a master transaction; and
if it is determined that the first transaction is a master transaction, identifying ones of the at least one enqueued transaction associated with the first transaction.

24. The computer program product recited in claim 23, the operation for identifying ones of the at least one enqueued transaction associated with the first transaction comprising, for ones of the enqueued transactions:
identifying a policy;
determining if the enqueued transaction can be a cause for the policy;
determining if the first transaction can be an effect of the policy; and
marking the enqueued transaction as the cause for the first transaction based in part upon the policy.

25. A method of processing transactions generated by a virtual prototyping environment comprising:
identifying a first transaction;
identifying a transaction queue, the transaction queue having at least one enqueued transaction;
enqueueing the first transaction into the transaction queue;
determining if the first transaction is a master transaction; and
if it is determined that the first transaction is a master transaction, identifying ones of the at least one enqueued transaction associated with the first transaction.

26. The method recited in claim 25, the operation for identifying ones of the at least one enqueued transaction associated with the first transaction comprising, for ones of the enqueued transactions:
identifying a policy;
determining if the enqueued transaction can be a cause for the policy;
determining if the first transaction can be an effect of the policy; and
marking the enqueued transaction as the cause for the first transaction based in part upon the policy.

27. A virtual prototyping environment comprising:
a processor, and
a memory including software instructions that cause the computer system to perform the following operations:
identifying a first module, the first module comprising at least one behavior;
identifying a second module, the second module comprising at least one timing policy;
instantiating both the first module and the second module through a module wrapper; and
scheduling a transactions by the module wrapper,
the scheduling based in part upon one of the at least one timing policies, and
the transaction corresponding to one of the at least one behaviors.

28. The virtual prototyping environment recited in claim 27, each of the at least one behaviors corresponding to at least one transaction.

29. The virtual prototyping environment recited in claim 28, each of the at least one timing policies describing a timing characteristic associated with at least one of the at least one transactions.

30. The virtual prototyping environment recited in claim 29, the operation for scheduling the transaction by the module wrapper comprising:
identifying an event,
the event implicating the transaction, and
the transaction being a timing transaction;
identifying a functional transaction, the functional transaction corresponding to the timing transaction;
identifying a policy associated with the functional transaction; and
scheduling the timing transaction based in part upon the policy.

31. The virtual prototyping environment recited in claim 30, the operation for scheduling the transaction by the module wrapper further comprising splitting the functional transaction into a plurality of sub-transactions based in part upon the policy.

32. The virtual prototyping environment recited in claim 31, the operation for splitting the second transaction into a plurality of sub-transactions based in part upon the policy comprising:
determining if the event implicates the start of the timing transaction;
determining if the timing transaction is a master transaction; and
splitting the functional transaction into a plurality of sub-transactions if,
it is determined that the event implicates the start of the timing transaction, and
it is determined that the timing transaction is a master transaction.

33. The virtual prototyping environment recited in claim 32, the predetermined operation for scheduling the timing transaction based in part upon the policy comprising scheduling the end of the transaction if it is determined that the event implicates the start of the timing transaction.

34. The virtual prototyping environment recited in claim 30, the operation for scheduling the timing transaction based in part upon the policy comprising:
determining if the functional transaction is a cause of the timing transaction;
determining if the event implicates the start of the timing transaction;
determining if the policy is a start dependant policy; and
scheduling the start of the timing transaction if,
it is determined that the functional transaction is a cause of the timing transaction, and
it is determined that the event implicates the start of the timing transaction, and
it is determined that the policy is a start dependant policy.

35. The virtual prototyping environment recited in claim 30, the operation for scheduling the timing transaction based in part upon the policy comprising:
determining if the functional transaction is a cause of the timing transaction;
determining if the event implicates the end of the timing transaction;
determining if the policy is an end dependant policy; and
scheduling the start of the timing transaction if,
it is determined that the functional transaction is a cause of the timing transaction, and
it is determined that the event implicates the end of the timing transaction, and
it is determined that the policy is an end dependant policy.

36. The virtual prototyping environment recited in claim 30, wherein the policy is one of the at least one timing policies.

37. The virtual prototyping environment recited in claim 29, the operation for scheduling the transaction by the module wrapper comprising:
identifying an event,
the event implicating the transaction, and
the transaction being a timing transaction;
identifying a functional transaction corresponding to the timing transaction from a queue of functional transactions;
determining if the event is an end event; and
removing the functional transaction from the queue of functional transactions if it is determined that the event is an end event.

38. A virtual prototyping environment comprising:
a processor, and
a memory including software instructions that cause the computer system to perform the following operations:
identifying a first transaction;
identifying a transaction queue, the transaction queue having at least one enqueued transaction;
enqueueing the first transaction into the transaction queue;
determining if the first transaction is a master transaction; and
if it is determined that the first transaction is a master transaction, identifying ones of the at least one enqueued transaction associated with the first transaction.

39. The virtual prototyping environment recited in claim 38, the operation for identifying ones of the at least one enqueued transaction associated with the first transaction comprising, for ones of the enqueued transactions:
identifying a policy;
determining if the enqueued transaction can be a cause for the policy;
determining if the first transaction can be an effect of the policy; and marking the enqueued transaction as the cause for the first transaction based in part upon the policy.
